(19) United States
(12) Patent Application Publication
(10) Pub. No.: US 2012/0215456 A1
(43) Pub. Date: Aug. 23, 2012

(54) SYSTEM AND METHOD FOR CELLULAR OPTICAL WAVEFRONT SENSING

(75) Inventors: John Hoffnagle, San Jose, CA (US); James Jacob, Scotts Valley, CA (US)

(73) Assignee: CytoRay, Scotts Valley, CA (US)

(21) Appl. No.: 13/032,652

(22) Filed: Feb. 23, 2011

(51) Int. Cl. G06F 19/00

(52) U.S. Cl. 702/19

(57) ABSTRACT

An optical system for non-invasive cytometry of mammalian cells includes a light source, a cell positioner, an optical imager, an optical wavefront sensor and a computer. The light source produces an illuminating beam of spatially coherent radiation. The cell positioner sequentially moves a single cell from a population of multiple cells into a sub-aperture region of the illumination beam whose wavefront is perturbed in response to the physical structure of the single cell. An optical system relays a magnified image of the sub-aperture region containing the cell to an image plane. At the image plane a Shack-Hartmann wavefront sensor is positioned. Within the pupil of the wavefront sensor the local tilts of the wavefront in the sub-aperture region are measured and sent to a computer. Software calculates the Zernike coefficients corresponding to the aberration induced by the structure of each cell. Their Zernike signatures classify the cells into distinct types.

### REFERENCES CITED

### U.S. Patent Documents

U.S. Pat. No. 7,804,794 9/2010 Vacca et al. 356/337

U.S. Pat. No. 5,017,497 5/1991 De Grooth et al.

### CROSS-REFERENCE TO RELATED APPLICATIONS

This application claims the benefit of U.S. Provisional Patent Application Ser. No. 61/306,830, “Cellular Analysis Using Optical Wavefront Sensing”, by John Hoffnagle and James Jacob, filed on Feb. 22, 2010, and of which subjects matter are incorporated herein by reference.

### BACKGROUND OF THE INVENTION

1. Field of the Invention

This invention relates generally to cytometry tools, and more particularly, to cell sorters and counters used in biotechnological applications such as stem cell research, cancer research, blood analysis, and general clinical studies.

2. Description of the Related Art

Cytometry is a set of techniques designed for counting, imaging, measuring specific cellular parameters and phenotypes. Cytometry provides the ability to analyze and identify individual cells in a large population of heterogeneous cells. The cells are imaged either on slides, micro-titer plates or as they flow through a channel suspended in a focused stream of isotonic media. The latter technique is known as flow cytometry and enables the sorting and purification of large numbers of a specific cell type. All flow cytometers consist of a light source, usually a laser, a channel in which suspended column of cells flow rapidly past an imaging port containing an opto-electrical detector. Cells are primarily analyzed with respect to their light scattering properties and fluorescent signatures. Flow cytometry is widely used in basic and translational biological research as well as clinically. Examples include counting and sorting blood cells, analyzing DNA content, detecting cells in precise stages of the cell cycle and cells undergoing apoptosis. Flow cytometry is routinely used to identify, sort and purify hematopoietic stem cells.

A key element of flow cytometry is the flow chamber. Through the use of a distinct fluid stream, the suspended cells are focused into the center of the fluid stream as they pass through the flow chamber. This enables all cells to be individually exposed to a beam of light. At this position, the cells are at the appropriate focal plane for emitted light to be collected by the optical system and captured by detectors. Typically detectors are positioned both perpendicular and directly in line with the excitation beam. The in-line detector detects light that is forward scattered at a low angle and thus provides information regarding cell size. The perpendicular detector detects high angle scatter, which is caused by highly refractive organelles in the cell such as a nucleus or large vesicles. Finally there is a second perpendicularly positioned detector dedicated for fluorescence detection. Due to a wealth of highly specific fluorescent probes, fluorescent-based flow cytometry has proven particularly powerful in identifying specific cell types. Specific cell types can be identified through highly specific antibodies to cell surface markers. This strategy has proven particularly effective in isolating hematopoietic stem cells. These antibodies can be directly tagged with a fluorophore or indirectly tagged using fluorescently-tagged secondary antibodies. Alternately there is a rapidly growing list of fluorescent small molecule probes that can be used to define cellular phenotypes.

While sorting cells through their forward and side scattering light properties is not as definitive as fluorescent-based cell sorting for identifying specific cell populations, it does have the advantage that it does not require labeling or any modification to the population of cells being analyzed and sorted. This non-invasive feature is particularly important if the cells will be used for in vivo studies. For example, stem cell-based therapies will require that the sorted cells be injected into the patient. For this reason, there is a tremendous need for a more sophisticated method of identifying specific cell types that does not rely on fluorescent labeling, yet can effectively analyze and classify unperturbed unlabeled cells.

### SUMMARY OF THE INVENTION

In accordance with the present invention, an optical system for label-free, non-invasive analysis of mammalian cells includes a light source, a cell positioner, an optical imager, a Shack-Hartmann optical wavefront sensor and a computer. The light source produces an illuminating beam of spatially coherent radiation. The cell positioner comprised of a sample of multiple cells and a mechanical stage or flow channel precisely positions a single cell within the sample into a sub-aperture region of the illumination beam. The cell perturbs the wavefront of the illumination beam according to the structure of the cell. The optical imager relays a magnified image of the sub-aperture region containing the single cell to an image plane. At the image plane the lenslet array of a Shack-Hartmann wavefront sensor is positioned. Within the pupil of the wavefront sensor the local tilts of the wavefront in the sub-aperture region are measured and sent to a computer. Software produces a set of Zernike coefficients corresponding to the aberrations induced by the morphology of each cell. Cells can then be sorted in a label-free fashion by their Zernike signature.

In a preferred embodiment, the light source comprises a fiber coupled semiconductor diode laser that emits radiation at a wavelength of 635 nm. The fiber output is connected to a lens that produces a collimated illumination beam that is directed into a conventional biological inverted microscope. The laser light is directed through the condenser lens of the microscope. The condenser lens focuses the laser beam to a spot on a microscope slide placed upon an XY translation stage mounted to the microscope body. The microscope slide comprises a sample of multiple mammalian cells distributed randomly. A single isolated cell is manipulated by the XY stage such that it is centered in a sub-aperture region of the laser illumination beam. The laser beam propagates through the cell and into an infinity-corrected objective lens. The objective lens in concert with the tube lens of the microscope provides a lateral magnification of 40×. The magnified image of the cell in the sub-aperture region is exited through an output port of the microscope and further relayed through an afocal beam-expanding telescope that provides an additional magnification of 3×, thereby producing an overall image magnification of 120×. At the plane of the image relayed by the telescope the lenslet array of a Shack-Hartmann wavefront sensor is positioned. The Shack-Hartmann wavefront sensor measures the wavefront tilts caused by the perturbation of the wavefront of the laser beam passing through the single cell on the slide. Using the wavefront tilt information a computer program calculates the Zernike coefficients of the wave aberrated by the cell. These Zernike coefficients provide a signature for the various cell types that are of interest to the biological researcher.

In further accordance with the present invention, a method for analyzing mammalian cells includes producing an illuminating beam of spatially coherent radiation then sequentially moving a single cell from a sample population of multiple cells to within a sub-aperture region of the illuminating beam of coherent radiation. Images of the single cells are magnified and the wavefront tilts of the illuminating beam of coherent radiation are measured. The Zernike coefficients associated with the wavefront distortion imparted on the illuminating beam of coherent radiation by each single cell are calculated and the cells in the sample population are classified according to their Zernike coefficient signatures.

### BRIEF DESCRIPTION OF THE DRAWINGS

FIG. 1 is a block diagram of an optical system 100 in accordance with the present invention;

FIG. 2 is a flow diagram illustrating operation of system 100;

FIG. 3 is schematic diagram of a preferred embodiment 300 of system 100;

FIG. 4 is a chart illustrating Zernike coefficients of a cell with a round shape; and

FIG. 5 is a chart illustrating Zernike coefficients of a cell with an elongated shape.

### DETAILED DESCRIPTION OF THE PREFERRED EMBODIMENTS

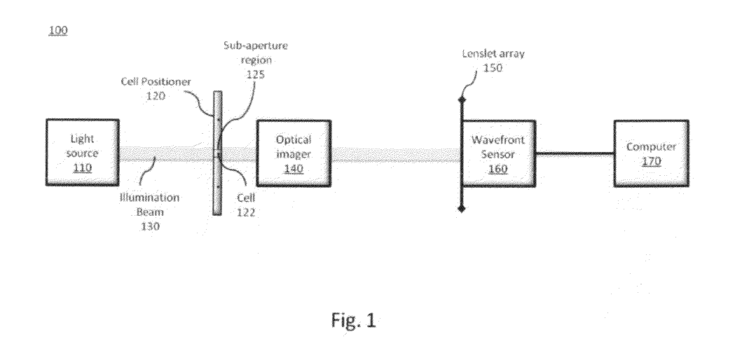

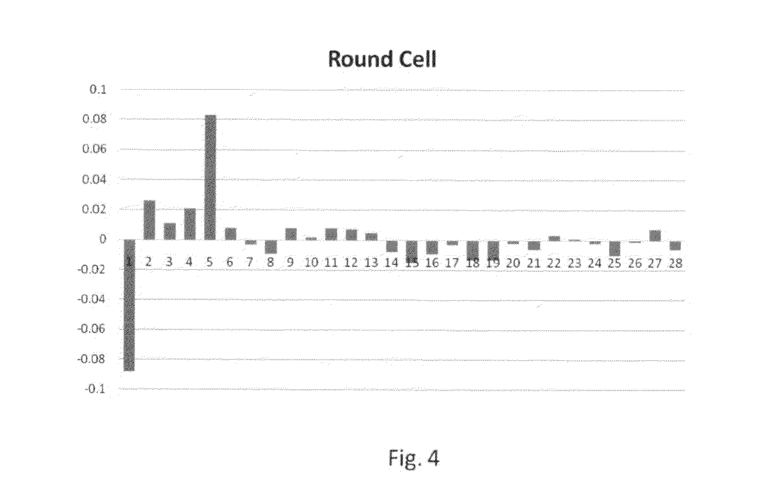

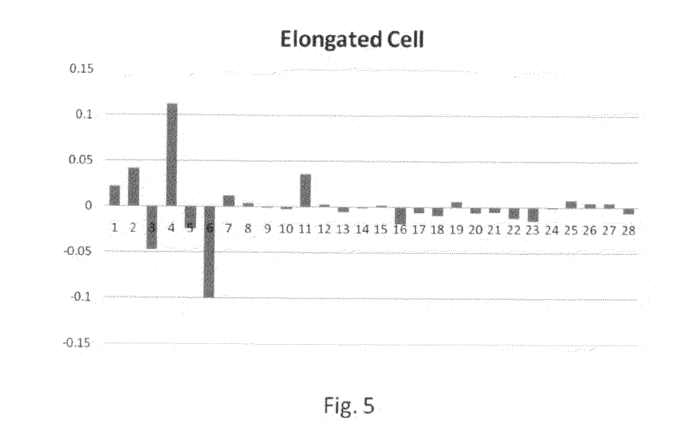

Referring now to the block diagram of FIG. 1, there is shown an optical system 100 that includes a light source 110, a cell positioner 120, an optical imager 140, a Shack-Hartmann wavefront sensor 160, and a computer 170. The light source 110 produces an illumination beam 130 of spatially coherent radiation that is directed toward a cell positioner 120 that includes a sample population of multiple mammalian cells 122. The cell positioner 120 sequentially directs single cells 122 into the sub-aperture region 125, located roughly in the center of the illumination beam 130. The physical structure of the cell 122 in the sub-aperture region 125 perturbs the wavefront of the illuminating beam 130. The optical imager 140 magnifies the image of the single cell 122 within the sub-aperture region 125 and relays the image of the cell 122 to an image plane where the lenslet array 150 of a Shack-Hartmann wavefront sensor 160 is positioned. The Shack-Hartmann sensor 160 measures the wavefront tilts imparted by the cell 122 onto the illumination beam 130. The computer 170, which includes analysis software, receives the wavefront tilt data from the Shack-Hartmann wavefront sensor 160 and its software calculates the Zernike coefficients (illustrated in FIG. 4 and FIG. 5) associated with aberrations present in the illuminating beam 130 due to the particular cell 122 that was sequentially moved into the sub-aperture region 125. The computer 170 further utilizes a sorting routine to classify the cells 122 according to their Zernike signatures. In this fashion the cells 122 in the sample population can be sorted, counted or selected for later clinical use.

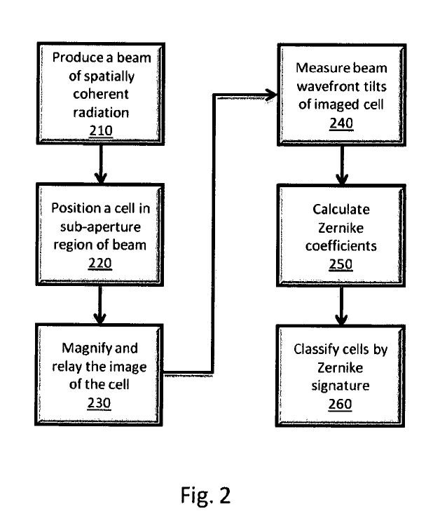

Referring now to the flow chart of FIG. 2, the light source 110 produces 210 an illumination beam 130 of spatially coherent radiation. The cell positioner 120 sequentially moves 220 a single cell 122 from the sample population into a sub-aperture region 125 of the illuminating beam 130. The optical imager 140 receives the illuminating beam 130 to magnify 230 and relay 230 the image of the cell 122 to the lenslet array 150 of a Shack-Hartmann wavefront sensor 160. The Shack-Hartmann wavefront sensor 160 measures 240 the wavefront tilts imparted by the cell 122 on the illumination beam 130. The computer 170 receives the measurement data form the Shack-Hartmann sensor 160 and its software calculates 250 the Zernike coefficients (e.g. FIG. 4 and FIG. 5) of the aberrated wavefront of the illumination beam 130. The computer 170 classifies 260 the cells 122 according to their Zernike signatures.

System 100 and the method of FIG. 2 are particularly advantageous because they discriminate the types of cells 122 in a non-invasive, label-free fashion (without using fluorescent markers), and thereby do not require additional preparation steps to label the cells 122 and do not modify the cells 122 under study. The use of Shack-Hartmann wavefront sensor 160 also provides high quality shape and structure information on cells 122 that is supplemental to the existing information acquired on conventional cytometry instruments.

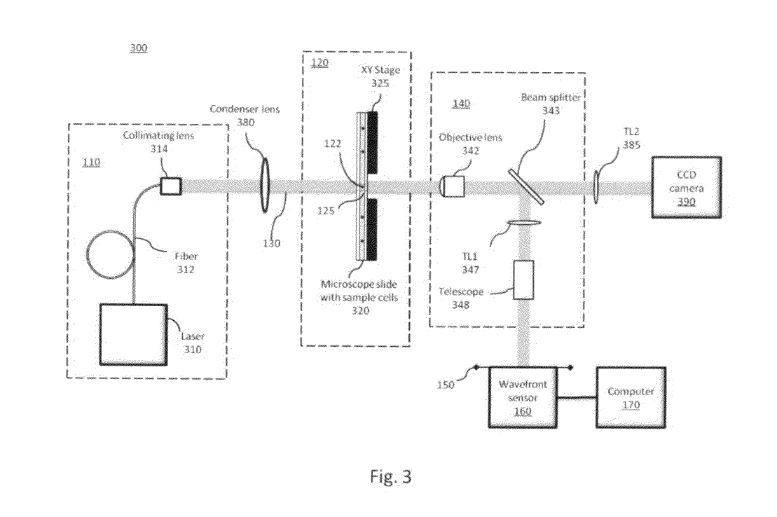

Referring now to the schematic of FIG. 3, the embodiment 300 includes condenser lens 380, tube lens TL2 385 and CCD camera 390 in addition to the components shown in FIG. 1. In addition the light source 110 includes a semiconductor diode laser 310, a fiber 312 and a collimating lens 314. The cell positioner 120 includes a microscope slide 320 that includes a sample population of cells 122 and is mounted to an XY translation stage 325. The optical imager 140 includes an objective lens 342, a beam splitter 343, a tube lens TL1 347 and a telescope 348. The Shack-Hartmann wavefront sensor 160 comprises a lenslet array 150 mounted at its front surface and a CCD sensor behind the lenslet array 150. The computer 170 includes a USB interface to the Shack-Hartmann wavefront sensor, analysis software that is provided with the Shack-Hartmann wavefront sensor 160, and an internal processor, memory and electronics typical of standard computer systems.

System 300 operates as follows. The light source 110 produces an illumination beam 130 that is collimated to a diameter of approximately 400 microns. Laser 310 has a wavelength that lies in the visible region of the electromagnetic spectrum, specifically at 635 nanometers (nm) in this particular embodiment. Condenser lens 380 focuses the illumination beam 130 into the cell positioner 120 to a spot diameter of about 100 microns. Cell positioner 120 sequentially moves single cells 122 into the analysis region represented by sub-aperture region 125. XY stage 325 bi-directionally translates, transverse to the propagating illumination beam 130, the microscope slide 320 such that a single cell 122, with a typical diameter of 10 microns, is centered within the sub-aperture 125. The sub-aperture 125 has a nominal diameter of 25 microns and is roughly defined as the center of the focused illumination beam 130. Optical imager 140 magnifies and relays the image of the single cell 122 in the sub-aperture region 125. Beam splitter 343 is placed in the tube section behind objective lens 342 to allow a portion of the illumination beam 130 to be transmitted towards the CCD camera 390 and a portion to be reflected towards Shack-Hartmann wavefront sensor 160. Objective lens 342 is focused to form an image at 40 × magnification of the object of the single cell 122 at the plane of the image sensor of CCD camera 390. This image is formed in concert with tube lens 112 385 and is used for observation, image recording and stage control. Objective lens 342 simultaneously works in concert with tube lens TL1 347 and telescope 348 to place a 120 × magnified image of the single cell 122 at the plane of a lenslet array 150, included in the Shack-Hartmann wavefront sensor 160. This image is parfocal with the observation image at the CCD camera 390. The Shack-Hartmann wavefront sensor 160 processes this image and measures the wavefront tilts of the wavefront aberrated by the single cell 122. The computer 170 receives the wavefront tilt measurements from the Shack-Hartmann wavefront sensor 160 and its software calculates the Zernike coefficients related to the aberrations imparted onto the illumination beam 130 by the single cell 122. The single cell 122 can then be classified by its Zernike coefficients which are unique for specific cell structures (e.g. FIG. 4 and FIG. 5). This process is thus repeated sequentially for as many cells as is required.

In more detail, semiconductor diode laser 310 in light source 110 is a Thor Labs Model S1FC635 Fabry-Perot laser that produces up to 2.5 milliwatts of average power at 635 nm. The fiber 312 is a Thor Labs P1-630A-FC-2 which is 2 meters long and is coupled via an FC/PC connector to the laser 310. The fiber 312 is a single mode type which produces an illumination beam 130 with a high spatial coherence (single transverse mode). This spatial coherence aspect of the laser 310 beam quality is important in deriving reliable wavefront tilt information. The collimating lens 314 is a Thor Labs CFC-2X-B aspheric lens with a 2 mm focal length and it also couples to the fiber 312 with an FC/PC connector. The focusing of this collimating lens 314 is adjustable to optimize the collimation of the diverging light emanating from the fiber 312 which has a mode field diameter of about 4.5 microns. The resulting collimated illumination beam 130 has an approximate diameter of 400 microns. The illumination beam is fed into the cell positioner 120 via condenser lens 380 directly or it can be directed via turning mirrors as is customary in laser optical systems.

A standard Olympus IX-71 brightfield inverted microscope is used as the mechanical structure in this system embodiment, although any commercial biological microscope or custom made microscope can be utilized as a system platform for optical system 300. The microscope provides the following components of optical system 300 shown in FIG. 3: the condenser lens 380, the tube lenses TL12 347 and TL2 385, the beam splitter 342, and the objective lens 342. The condenser lens 380 comprises Olympus model U-UCD8 universal condenser mount with an Olympus U-TLD lens. The objective lens 342 is Olympus model SLCPLFL infinity corrected, long working distance objective lens with an NA of 0.55 and a working distance of 7.7 mm. At the standard Olympus microscope tube length of 180 mm the objective lens 342 provides a magnification of 40×. The objective lens 342 is positioned such that its front mechanical surface is approximately placed at its working distance of 7.7 mm from the object location of the single cell 122 in sub-aperture region 125. The beam splitter 342 and the tube lenses TL1 347 and TL2 385 are included in the microscope assembly, TL2 385 being used in the observation role with CCD camera 390 and TL1 347 as part of the optical imager 140 which images the cell 122 onto the lenslet array 150 of Shack-Hartmann wavefront sensor 160. The CCD camera 390 is a Sony XCD-V50 in this embodiment and is used for observing the cells 122, controlling the cell positioner 120, and recording images of the cell 122 being analyzed as needed.

The telescope 348 is a CVI Melles-Griot model CWBX-7.0-3X-633 laser beam expander which is anti-reflection coated at 635 nm and provides an additional magnification of 3×, for an overall image magnification of 120×. Telescope 348 is mounted external to the microscope on a stable table surface. The image of the 10-micron diameter cell 122 is thus magnified to 1.2 mm at the intermediate image plane coinciding with the lenslet array 150 of the Shack Hartmann sensor 160. The 25 micron-diameter sub-aperture region 125 is likewise magnified to 3 mm at the lenslet array 150.

Cell positioner 120 in this particular embodiment comprises an automated XY stage 325 that is retrofitted to the Olympus IX-71 stand and a microscope slide 320 of the standard laboratory variety that includes a sample population of cells 122 placed under a cover slip about one millimeter thick. The XY stage 325 is a Prior Scientific H117 ProScan automated stage with 1 micron repeatability and a stage speed of 60 mm/s. Single cells 122 are sequentially positioned by the XY stage 325 into the sub-aperture region, either manually by the operator or under control of computer 170 using standard machine vision software that uses the imagery on camera 390 in concert with XY stage 325 motion control software.

We now give a brief explanation on the workings of the Shack-Ha rtmann wavefront sensor 160 and on Zernike coefficients:

For wavefront analysis it is useful to write the two-dimensional function W(x,y) as a finite series of orthogonal polynomials, where, the Zⱼ(x,y) are Zernike polynomials and the Zernike coefficients cⱼ are weighting factors. The Zernike coefficients describe the wavefront in a concise way which connects to classical aberration theory. In the context of cell 122 sorting, the Zernike coefficients are valuable because they are related to the morphology of an object that perturbs an incident plane wave illumination beam 130. For instance, a subset of the Zernike polynomials is invariant with respect to a coordinate rotation about the z-axis. For a rotationally symmetric perturber, such as a spherical cell 122 (FIG. 4), only the coefficients of these polynomials can have non-vanishing values. However, for a non-rotationally symmetric perturber, such as an elongated cell 122 (FIG. 5), the coefficients of the other Zernike polynomials can also take on non-vanishing values, and their exact values depend on the elongation and orientation of the perturber. The Zⱼ(x,y) are polynomials in x and y, and they are ordered so that the smaller values of j correspond to smaller powers of x and y. Consequently, the lower order terms in the series expression for the wavefront are most sensitive to the overall shape of the perturber, whereas high spatial frequency features, for instance from intracellular structures, mainly affect the higher order coefficients. The Zernike series representation thus provides a compact way of presenting just the information required for analysis of cell 122 morphology.

Real-time data for the Zernike coefficients of an aberrated plane wave can be acquired with a Shack-Hartmann wavefront sensor 160. This device, which is in widespread use in adaptive optics applications, uses a lenslet array 150 and CCD sensor to directly measure the tilts of the wavefront, that is δW/δx and δW/δ_{y} , on a grid of x and y values. An array of identical microlenses is positioned one focal length from a CCD array, with the pitch of the lenslet array being larger by some factor (typically 4-10) than that of the CCD, so that the spot of light focused by each lenslet falls within a group of CCD pixels. According to the principles of Fourier optics, each lenslet performs a Fourier transform operation that maps the wavevector k=(kₓ, k_{y}) of the incident beam (averaged over the lenslet aperture) to a spatial coordinate r=(rₓ, r_{y}) on the CCD array. The focal length and numerical aperture of the lenslet array 150 and the size of the CCD pixels are chosen so that the diffraction limited spot on the CCD extends over several pixels, which allows the centroid of the spot to be determined to sub-pixel accuracy. From the measured centroid positions and the known focal length of the lenslets one deduces the wave vector components kₓ and k_{y}, which are proportional to δW/δx and δW/δy . One can “integrate” the partial derivatives to reconstruct the wavefront W(x, y), or use least-squares fitting to find the set of Zernike coefficients that best describes the measured wavefront tilts.

The Shack-Hartmann wavefront sensor 160 used in the preferred embodiment is a Thor Labs model WFS300-14AR which has a lenslet array 150 consisting of 15 by 19 micro-lenses and a CCD with 1280 by 1024 pixels each measuring 4.65 by 4.65 microns. The specified wavefront sensitivity at 633 nm is 1/150 of a wavelength. The pupil area (analysis region) is set by software in computer 170 at 3 mm to equal the diameter of the magnified sub-aperture region 125 containing cell 122 (25 microns multiplied by the 120× image magnification). The cell 122 thus extends over a 1.2 mm region within the pupil. This is an optimum ratio for the Shack-Hartmann wavefront sensor 160 to operate.

The computer 170 is a standard Intel microprocessor based PC loaded with the Thor Labs software to run the WFS300-14AR Shack-Hartmann wavefront sensor 160. The wavefront tilts are processed as described above and the Zernike coefficients are calculated as shown in the examples of FIG. 4 and FIG. 5.

What is claimed is:

1. An optical system for analyzing mammalian cells comprising:
a light source for producing an illuminating beam of spatially coherent radiation;
a cell positioner disposed to sequentially move a single cell from a sample population of multiple cells to within a sub-aperture region of said illuminating beam of spatially coherent radiation;
an optical imaging system disposed to magnify and relay the images of the single cells sequentially moved into the sub-aperture region of said illuminating beam of spatially coherent radiation;
a Shack-Hartmann optical wavefront sensor disposed to receive the sequential images of the single cells from said optical imager for measurement of the local wavefront tilts of the illuminating beam of spatially coherent radiation;
a computer disposed to receive the wavefront tilt measurement information from said Shack-Hartmann wavefront sensor;
a wavefront calculation program disposed to process the wavefront tilt measurement information in said computer for calculating the Zernike coefficients associated with the wavefront distortion caused by each single cell sequentially moved into the illuminating beam of coherent radiation; and
a sorting software routine disposed to process the Zernike coefficients provided by said wavefront calculation program for classifying the cells according their Zernike signatures.

2. The optical system of claim 1 wherein the wavelength of the light source lies in the electromagnetic spectrum between about 400-1100 nm.

3. The optical system of claim 1 wherein the light source is a laser

4. The optical system of claim 1 wherein the cell positioner comprises a micro-fluidic channel.

5. The optical system of claim 1 wherein the cell positioner comprises a fluid flow stream.

6. The optical system of claim 1 wherein the cell positioner comprises a microscope slide mounted on an XY mechanical stage.

7. The optical system of claim 1 wherein the optical imager provides an overall magnification in the range of about 100-200X.

8. A method for analyzing mammalian cells comprising:
producing an illuminating beam of coherent radiation;
sequentially moving a single cell from a sample population of multiple cells to within a sub-aperture region of the illuminating beam of coherent radiation; magnifying and relaying the images of the single cells sequentially moved to within the sub-aperture region of the illuminating beam of coherent radiation;
receiving the magnified and relayed sequential images of the single cells and measuring the wavefront tilts of the illuminating beam of coherent radiation;
calculating the Zernike coefficients associated with the wavefront distortion imparted on the illuminating beam of coherent radiation by each single cell; and
classifying the sequentially illuminated cells according their Zernike coefficient signatures.

9. The method of claim 8 wherein the coherent radiation lies in the wavelength region of about 400-1100 nm.

10. The method of claim 8 wherein the overall magnification of the single cell images is in the range of about 100-200X.
